(19) United States
(12) Patent Application Publication
(10) Pub. No.: US 2012/0293996 A1
(43) Pub. Date: Nov. 22, 2012

(54) MULTI-ADJUSTABLE REPLACEMENT LED LIGHTING ELEMENT

(76) Inventors: James Thomas, Tierra Verde, FL (US); Gary Gatesman, Indian Rocks Beach, FL (US); James Mosier, St. Petersburg, FL (US); David Lynd, Seminole, FL (US); Brandon Scott Abril, Largo, FL (US)

(21) Appl. No.: 13/426,212

(22) Filed: Mar. 21, 2012

Related U.S. Application Data
(60) Provisional application No. 61/454,951, filed on Mar. 21, 2011.

(51) Int. Cl. F21V 21/00; F21V 5/04; F21V 29/00

(52) U.S. Cl. 362/235; 362/249.02

(57) ABSTRACT

An LED lighting element is configured to receive electrical power from a fluorescent lighting fixture ballast. The LED lighting element includes a base and a light engine coupled to the base. The light engine includes at least one LED. An end cap is coupled to the base and defines an enclosed chamber. A converter module is housed within the enclosed chamber and is electrically coupled to the light engine. The converter module is configured to convert AC power from the fluorescent lighting fixture ballast to DC power for powering the at least one LED.

### CROSS-REFERENCE TO RELATED APPLICATIONS

This application claims the benefit of and priority to U.S. Provisional Patent Application No. 61/454,951, filed Mar. 21, 2011, the entire contents of which are hereby incorporated by reference herein.

### TECHNICAL FIELD

This invention relates to a multi-adjustable LED lighting element that replaces a fluorescent lighting element within the existing light fixture, and that operates with the existing ballast.

### BACKGROUND OF THE INVENTION

Conventional fluorescent light fixtures can be found in a variety of commercial, residential and retail applications. These fixtures typically include a housing, an electronic ballast and at least one fluorescent light tube, which may be linear or curvilinear. The ballast is electrically connected to the power supply, is installed within the fixture housing, and limits the amount of current supplied to the light tube(s). Conventional fluorescent light fixtures suffer from a number of limitations, including high operating voltages, high power consumption, short life expectancy, and/or poor light output quality in terms of both color temperature and color rendering. Based upon these and other limitations, various third-parties have pursued other avenues to improve the operation of conventional fluorescent light fixtures. One alternative is replacing the fluorescent lamps of conventional fluorescent light fixtures with LED lighting elements. LEDs by design are more durable, have longer life expectancy, and have superior light quality when measured in terms of color temperature and color rendering as compared to fluorescent lamps. However, the ability to replace fluorescent lamps with LEDs is hindered by operating differences between the two light sources.

Fluorescent lamps or lighting elements are primarily driven by electronic ballasts. These ballasts drive the lamps with alternating current (AC) signals, that are generally characterized by high frequency, high voltage with high peak voltages, and constant current with high peak currents. LEDs, on the other hand, operate on low voltage direct current (DC). Although they can be arrayed in series to create strings that operate at higher voltages, they still require a DC power supply to illuminate. The LEDs will only illuminate with current passing through them in one direction (DC), and, if driven with an AC power supply used to power fluorescent lamps, will only illuminate approximately half of the time when the AC signal is the correct polarity. These operating differences may require replacement of not only the fluorescent bulb itself, but also other components in the fluorescent lighting fixture, resulting in high cost and expenditure of time.

The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

In some aspects, an LED lighting element is configured to receive electrical power from a fluorescent lighting fixture ballast. The LED lighting element includes a base and a light engine coupled to the base. The light engine includes at least one LED. An end cap is coupled to the base and defines an enclosed chamber. A converter module is housed within the enclosed chamber and is electrically coupled to the light engine. The converter module is configured to convert AC power from the fluorescent lighting fixture ballast to DC power for powering the at least one LED.

In other aspects, an LED lighting element is configured to receive electrical power from a fluorescent lighting fixture ballast. The LED lighting element includes an end cap assembly having a first cap engageable with the fluorescent lighting fixture ballast and a second cap rotatably coupled to the first cap for rotation about a longitudinal axis of the lighting element. A plurality of LEDs are coupled to the second cap for rotation therewith with respect to the first cap. Each of the plurality of LEDs is positioned to emit light in a first direction that is substantially perpendicular to the longitudinal axis. A converter module is electrically coupled to the LEDs for converting AC power received from the fluorescent lighting fixture ballast to DC power for powering the plurality of LEDs.

In still other aspects, an LED lighting element is configured to receive electrical power from a fluorescent lighting fixture ballast. The LED lighting element includes an elongated base defining a longitudinal axis and having a first side and a second side. The first side includes a lens mounting arrangement defining a channel, and the second side includes a plurality of outwardly extending fins that define a heat sink. A light engine is coupled to the base and includes a plurality of LEDs. A lens is positioned within the channel and overlies the light engine. A pair of adjustable end cap assemblies are each affixed to a respective end of the base and include an outer end cap rotatably coupled to an inner end cap for rotation about the longitudinal axis. One of the inner end cap and the outer end cap includes a portion having a plurality of circumferentially spaced apart pins, and the other of the inner end cap and the outer end cap includes a portion defining a plurality of circumferentially spaced apart recesses configured to receive the pins. Each end cap assembly includes a biasing member biasing the pins into engagement with the recesses. Two converter modules are electrically coupled to the plurality of LEDs and are configured to convert AC power received from the fluorescent lighting fixture ballast to DC power for powering the plurality of LEDs. Each converter module is located within a chamber formed in a respective one of the end cap assemblies.

Other features and advantages of the invention will be apparent from the following specification taken in conjunction with the following drawings

### BRIEF DESCRIPTION OF THE DRAWINGS

To understand the present invention, it will now be described by way of example, with reference to the accompanying drawings in which:

FIG. 1 is an exploded perspective view of an exemplary LED lighting element according to the current design;

FIG. 2 is an end view of a base extrusion for the LED lighting element of FIG. 1;

FIG. 3 is a partial side view of the LED lighting element of FIG. 1;

FIG. 4 is a partial cross-sectional view taken along line 4-4 of FIG. 3;

FIGS. 5a and 5b are perspective views showing the outer and inner ends, respectively, of an inner end cap of the LED lighting clement of FIG. 1;

FIG. 6 is an end view of the inner end cap of the LED lighting element of FIG. 1;

FIG. 7 is a side view of the inner end cap of the LED lighting element of FIG. 1;

FIG. 8 is a section view taken along line 8-8 of FIG. 6;

FIGS. 9a and 9b are perspective views showing the inner and outer ends, respectively, of an outer end cap of the LED lighting element of FIG. 1;

FIG. 10 is an end view of the outer end cap of the LED lighting element of FIG. 1;

FIG. 11 is a side view of the outer end cap of the LED lighting element of FIG. 1;

FIG. 12 is a section view taken along line 12-12 of FIG. 10; and

FIG. 13 is a perspective view of a converter module of the LED lighting element of FIG. 1.

### DETAILED DESCRIPTION

While this invention is susceptible to embodiments in many different forms, there are shown in the drawings and will herein be described in detail preferred embodiments of the invention with the understanding that the present disclosure is to be considered as an exemplification of the principles of the invention and is not intended to limit the broad aspect of the invention to the embodiments illustrated.

A multi-adjustable LED lighting element can replace a fluorescent lamp in an existing fluorescent lighting fixture while being powered by the existing ballast. FIG. 1 shows an exploded view of one embodiment of a lighting element 10 having an elongated base 200, light engine 300, inner lens 400, outer lens 450, a pair of adjustable end cap assemblies 500 that each include an inner end cap 600 and an outer end cap 700, and a converter module 800. Each outer end cap 700 is rotatable with respect to its respective, inner end cap 600 about an axis 901. The interaction of these components allows the lighting element 10 to be adjusted among a variety of angular positions for changing the general direction of light emitted from the lighting element 10, as discussed below.

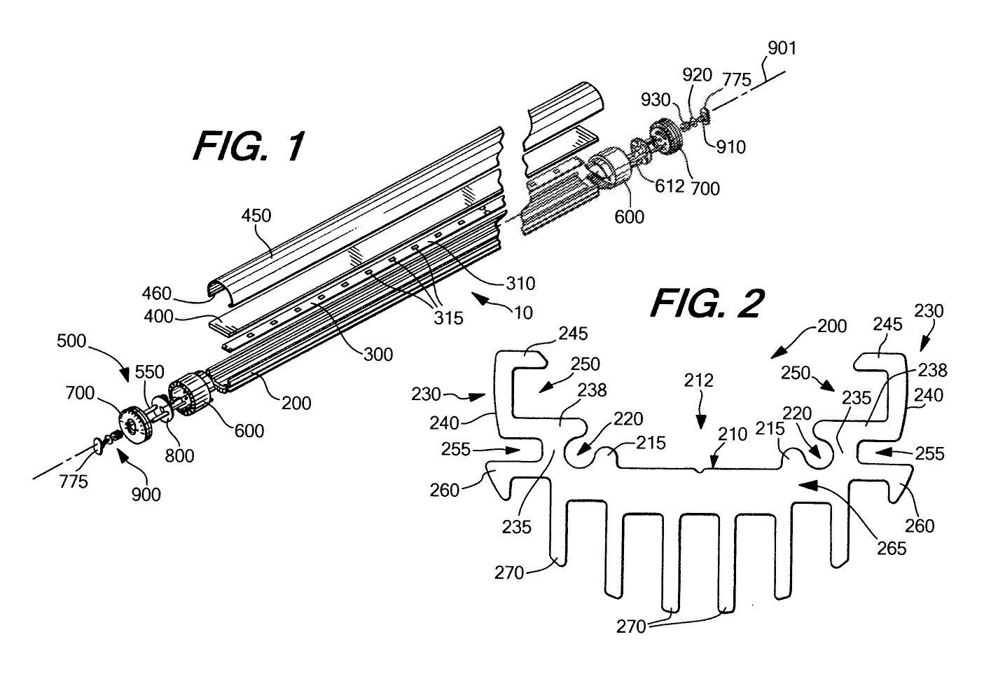

Referring also to FIG. 2, the base 200 is an elongated structure with a substantially flat intermediate surface 210 that extends along the length of the base 200 and that defines a mounting surface for light engine 300. Protrusions 215 extend away from respective opposite outer edges of the intermediate surface 210, and cooperate with the intermediate surface 210 to define a mounting cavity 212. An intermediate wall 235 is located outwardly of each protrusion 215 and each intermediate wall 235 cooperates with a respective protrusion 215 to define a curvilinear recess 220 that, in the illustrated embodiment, extends along the length of the base 200. A lens mounting arrangement 230 extends from each intermediate wall 235 and along the length of the base 200. Each lens mounting arrangement 230 is substantially C-shaped and includes an inner wall 238 oriented substantially parallel to the intermediate surface 210, a side wall 240 extending from an outer edge of each inner wall 238 in a direction substantially perpendicular to the intermediate surface 210, and an outer wall 245 that extends inwardly from a distal end of each side wall 240. The inner wall 238, side wall 240, and outer wall 245 of each lens mounting arrangement 230 cooperate to define a channel 250 that receives the inner lens 400. A generally outwardly extending medial wall 260 extends outwardly from the base of each intermediate wall 235 and cooperates with a respective inner wall 238 to define a generally inwardly directed receiver 255.

An intermediate portion 265 of the base 200 includes an arrangement of fins 270 that extend in opposite directions from the protrusions 215 and intermediate wall 235. The fins 270 are substantially parallel to one another and have varying lengths that cooperate to define a generally curvilinear outer profile. Preferably, fins 270 have varying length with the longer fins located at the center portion of base 200 and then decreasing in length in each direction toward the outer edges of the base 200. The fins 270 together define a heat sink and transfer heat away from the LED light engine 300. In the current example, base 200 is made from an extrusion of aluminum, but other materials and manufacturing methods may also or alternatively be used.

Returning to FIG. 1, light engine 300 is positioned in the mounting cavity 212 and mounted to the base 200. The light engine 300 includes soldered jumpers and/or other electro mechanical connectors such that the ends of the light engine 300 are substantially electronically coupled to one another. The light engine 300 faces generally in a direction that is substantially perpendicular to the axis 901. The light engine includes at least one printed circuit board (PCB) 310 and a plurality of LEDs 315 spaced apart along the PCB 310. In the illustrated embodiment the LEDs 315 are substantially coplanar with each other. In other embodiments the LEDs 315 may be angled with respect to the surface of the light engine 300 and with respect to one another, such that the LEDs 310 are not necessarily coplanar with one another. Regardless of the specific angular alignment of the LEDs 315 with each other and with the light engine 300, the LEDs 315 are generally configured and arranged to emit light in a direction substantially perpendicular to the axis 901.

At least one end of the light engine 300 is electrically coupled to the converter module 800 located within inner end cap 600, for example by insulated jacketed wires with stripped and soldered ends. The light engine 300 is mounted to the base 200 using a high bond adhesive tape (not shown). The tape used to mount the light engine 300 to the upper surface may have a thickness of about 5-20 mils, and may also have a relatively high thermal conductivity. In some embodiments, the light engine 300 includes copper pads (not shown) spaced along its lower surface. The copper pads improve heat transfer away from the light engine 300 through the adhesive tape to the base 200 and fins 270 to dissipate heat generated by the light engine 300 into the environment.

A substantially flat and transparent inner lens 400 is received within the channel 250 of the lens mounting arrangement 230 and overlies the light engine 300. In some embodiments, the inner lens 400 is made from optically efficient water clear polycarbonate. In the illustrated embodiment the inner lens 400 has a thickness of about 3 millimeters; however, the thickness may vary depending on the type of material used and the configuration of the lens mounting arrangement 230. The inner lens 400 is slid into the channel 250 and retained in place using end caps 500, as discussed below.

An optional outer lens 450 has a generally semi-circular cross-section with two inwardly extending projections 460 at opposed outer edges. The inner projections 460 are inserted into the receivers 255 such that the outer lens 450 snaps onto the base 200. The inner surface of the outer lens 450 may contact the side wall 240 and receive additional support therefrom. In some embodiments, the optional outer lens 450 is made out of optically efficient polycarbonate, and may be added to the lighting element 10 to provide additional diffusion or collimation of light.

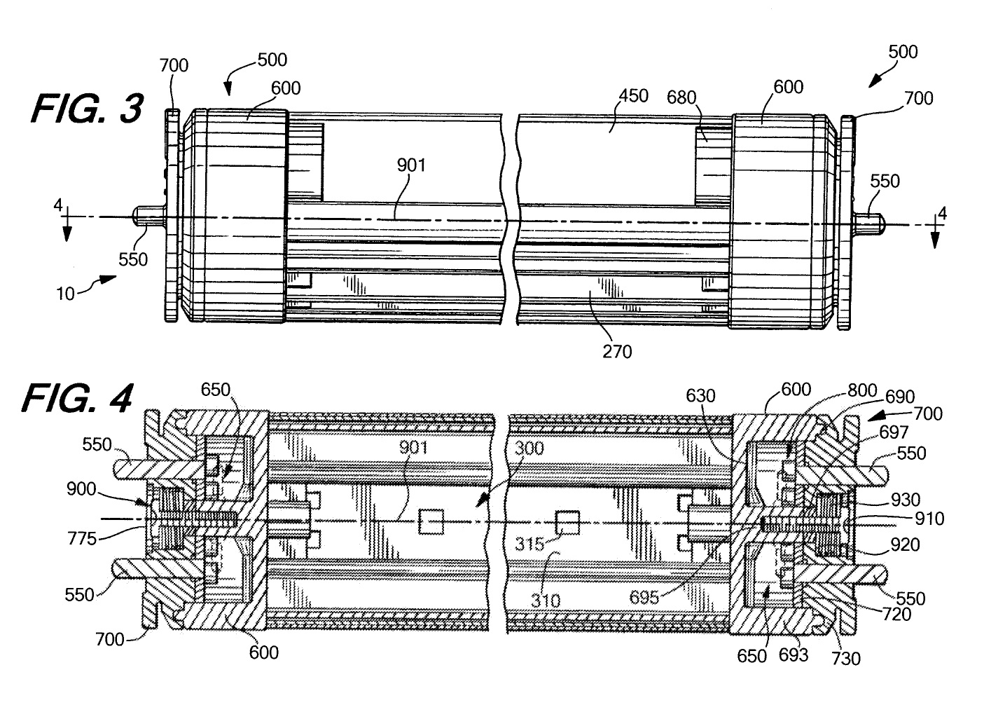

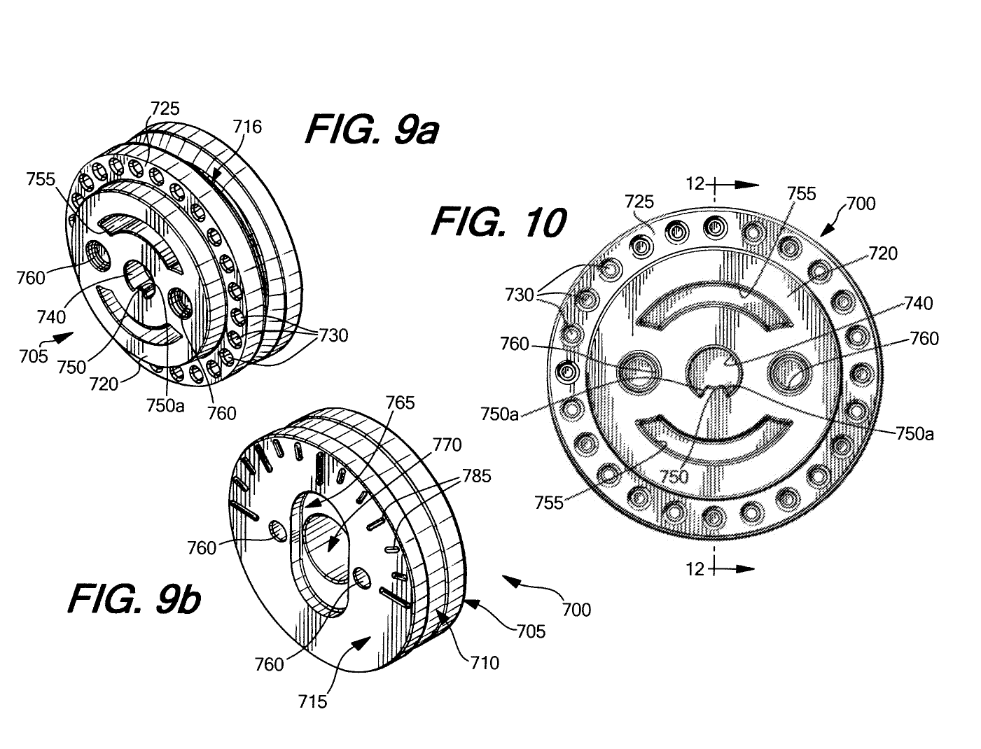

Referring also to FIGS. 3 and 4, each adjustable cap assembly 500 includes the fixed inner cap 600 and the outer cap 700 that is rotatable with respect to the inner cap 600 about the axis 901. The inner cap 600 and outer cap 700, when assembled as shown in FIG. 4, cooperate to define a distinct enclosed chamber 650 that provides a high voltage enclosure around the converter module 800. Two electrically conductive pins 550 are electrically coupled to the converter module 800 within cap assembly 500 and extend through holes 760 in the outer cap 700 (FIGS. 9a, 9b, and 10) to provide electrical connection to the ballast of the existing fluorescent light fixture. The pins 550 are rotatable with the outer cap 700 relative to the inner cap 600.

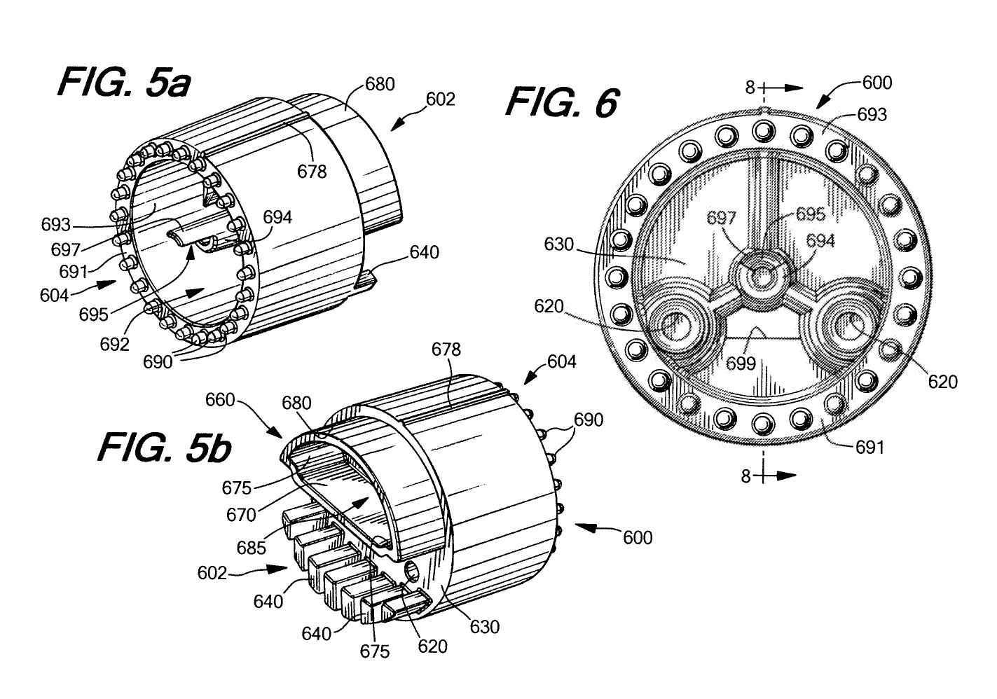

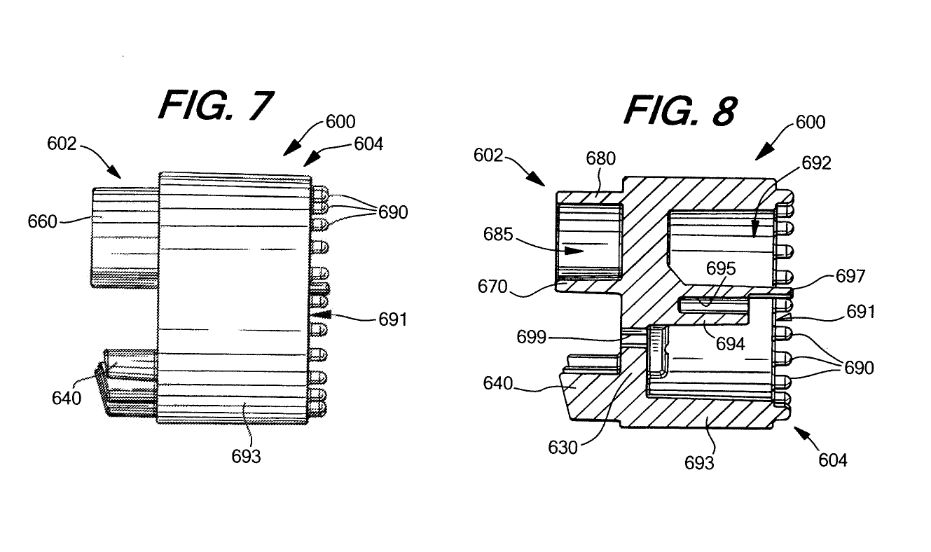

Referring also to FIGS. 5a, 5b, and 6 through 8, the inner cap 600 includes an interior wall 630, an outer portion 604 extending from one side of the interior wall 630 and an inner portion 602 extending from another side of the interior wall 630. The inner cap 600 is coupled to the base 200 using fasteners 612 (FIG. 1) that extend through openings 620 in the interior wall 630. The fasteners 612 are received within the recesses 220 formed in the base 200 (FIG. 2). The inner portion 602 includes a plurality of teeth 640 that extend away from the interior wall 630 and that are configured and dimensioned to intermesh with fins 270 of the base extrusion 200 (FIG. 2) when the inner cap 600 is secured to the base 200. The inner portion 602 also includes a semi-circular projection 660 that extends from the interior wall 630 and includes a substantially linear bottom wall 670 and curved upper wall 680 that cooperate to define a cavity 685. Inclined corner segments 675 extend between the substantially linear bottom wall 670 and the curved upper wall 680.

When assembled in the manner shown in FIGS. 3 and 4, the inclined corner segments 675 of the inner cap 600 receive the inner ends of the outer walls 245 of the base 200. The curved upper wall 680 includes a curvature that compliments the curvature of the outer lens 450 such that the outer lens mates with the upper wall 680 and is supported thereby. The bottom wall 670 contacts the inner lens 400, preferably an outer surface of the inner lens 400, to further secure the inner lens 400 within the channel 250 in the assembled position.

The outer portion 604 of the inner cap 600 includes a substantially cylindrical sidewall 693 that extends axially from the interior wall 630 and defines a central cavity 692. A plurality of first alignment features in the form of pins or projections 690 extend axially outwardly from an annular end surface 691 of the sidewall 693. The pins 690 are circumferentially spaced about the annular end surface 693. A central projection 694 extends axially from the interior wall 630 into the central cavity 692. The central projection 694 defines a threaded bore 695 that receives a portion of fastening means 900, as discussed below. The projection 694 also includes an axially extending key 697 having an arcuate cross section that extends through approximately 90 degrees. An axially-extending rib 678 is formed on the outer surface of the sidewall 693 and is substantially radially aligned with the key 697. The rib 678 provides a visual reference frame to indicate the relative rotational position of the inner cap 600 with respect to the outer cap 700. A wire opening 699 extends through the interior wall 630 at a location adjacent the projection 694 and receives wires for electrically coupling the light engine 300 to the converter module 800. When assembled, at least one of the light engine 300 and the base 200 abuts the interior wall 630 and covers the wire opening 699.

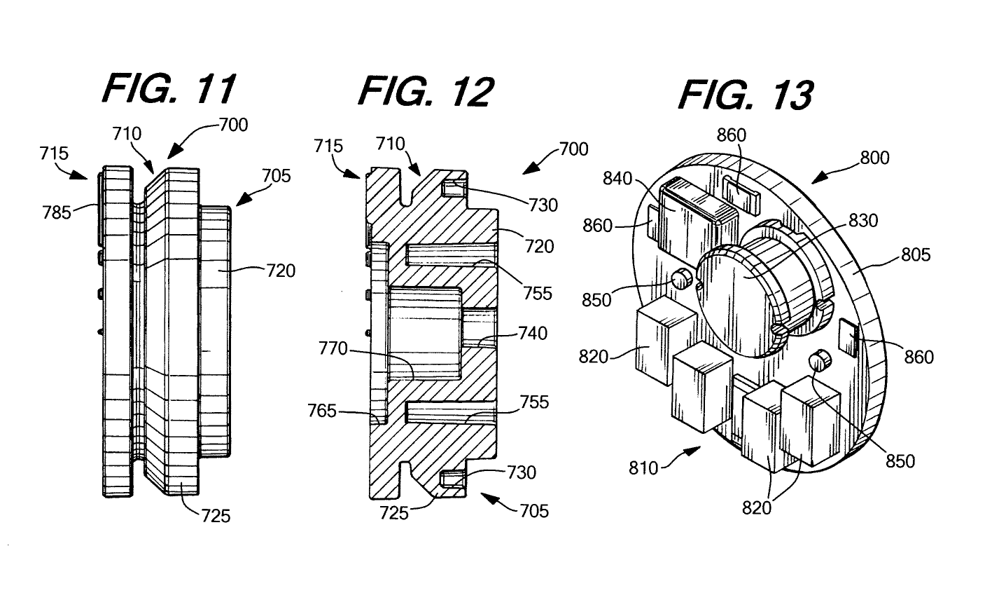

Referring also to FIGS. 9a, 9b, and 10 through 12, the outer cap 700 includes an inner portion 705, a recessed intermediate portion 710 and an outer portion 715. The inner portion 705 includes a raised central disk 720 and a recessed peripheral rim 725 that defines a plurality of second alignment features in the form of axially extending recesses 730 circumferentially spaced around the peripheral rim 725. In the illustrated embodiment there are twenty-four (24) recesses 730 that are cooperatively dimensioned and spaced to receive the pins 690 of the inner cap 600.

A central bore 740 extends through the outer cap 700 and includes a notch 750 defined by angled side surfaces 750a within the central bore 740. The angled side surfaces 750a engage the key 697 formed on the central projection 694 of the inner cap 600 to limit an extent of rotation of the outer cap 700 with respect to the inner cap 600. The outer cap 700 also includes a pair of substantially diametrically opposed apertures 760 extending therethrough. Each aperture 760 receives one of the pins 550 for connecting with the socket connectors associated with the ballast of the existing fluorescent light fixture. The central disk 720 also defines arcuate slots 755 residing radially outward of the central bore 740 that provide the inner disk 720 with more consistent cross sections and wall thicknesses to improve manufacturability.

The outer portion 715 of the outer cap 700 includes an elongated external recess 765 that surrounds an enlarged and countersunk opening 770 that opens to the central bore 740. The outer portion 715 also includes indicia in the form of a plurality of radially extending ridges 785 that are circumferentially spaced apart around approximately an upper half of the outer portion 715. The radial spacing of the ridges 785 substantially corresponds to the radial spacing of the pins 690 and recesses 730, which in the illustrated embodiment is approximately 15 degrees. The location of the ridges 785 relative to the rib 678 on the inner cap 600 provides a visual indication of the relative rotational alignment of the outer cap 700 with respect to the inner cap 600.

As best shown in FIG. 4, the outer cap 700 is rotatably coupled to the inner cap 600 by an adjustable fastening means 900. In the illustrated embodiment, the fastening means 900 includes a threaded fastener 910 that extends through the central bore 740 in the outer cap 700 and threads into the threaded bore 695 of the inner cap 600. A washer 920 and a biasing member in the form of a spring 930 are located in the countersunk opening 770 of the outer cap 700 and are captured between the head of the fastener 910 inner portion 705 of the outer cap 700. When assembled, the spring 930 biases the outer cap 700 toward the inner cap 600 such that the pins 690 are biased into engagement with the recesses 730. The external recess 765 of the outer cap 700 receives a removable cap 775 (see FIG. 1) that covers the fastening means 900.

The inner cap 600, along with the inner lens 400 and the base 200 cooperate to define a second high voltage enclosure around light engine 300 to improve safety and maintain operability. Both the high voltage enclosure defined by the chamber 650 and surrounding the converter module 800 and the high voltage enclosure surrounding the light engine 300 and defined by the inner cap 600, inner lens 400, and base 200 comply with the standard UL1993 Underwriters Laboratories, Inc. (UL) Standard for Safety for Self-Ballasted Lamps and Lamp Adapters.

Referring to FIG. 13, the converter module 800 converts the AC power from the fluorescent lighting fixture's pre-existing ballast into DC power for powering the LEDs. The converter module 800 is described in U.S. patent application Ser. No. 12/950,897, filed Nov. 19, 2010, the entire contents of which are hereby incorporated by reference. The converter module 800 generally comprises a printed circuit board (PCB) 805 having a bridge rectifier 810, a plurality of resistors 820, an inductor 830 and a capacitor 840. As shown in FIG. 4, the module 800 is positioned against the central disk 720 of the inner portion 705 of the outer cap 700 and is located within the enclosed chamber 650 cooperatively defined by the inner cap 600 and the outer cap 700.

The PCB 805 includes a central opening (not shown) that receives the central projection 694 of the inner cap 600. The PCB 805 also includes a pair of holes 850 for receiving the connector pins 550. When located in the holes 850 the connector pins are electrically coupled to the PCB 805 such that the PCB receives AC power from the fluorescent lighting fixture ballast by way of the pins 550. The converter module 800 is electrically coupled to the light engine 300 by a pair of wires (not shown) that extend from solder pads 860 on the converter module 800 through the wire opening 699 (FIGS. 6 and 8) in the inner cap 600. The wires are provided with sufficient slack to allow for rotation of the outer cap 700 relative to inner cap 600, wherein the slack is retained in the cavity 692 of the outer portion 604.

In the assembled configuration of FIGS. 3 and 4, the outer cap 700 is rotatably connected to the inner cap 600 for rotation about the axis 901 by the fastening means 900. The threaded fastener 910 extends through the central bore 740 of the outer cap 700 and is received by the threaded bore 695 of the inner cap 600. However, the central bore 740 of the outer cap 700 has a larger diameter than the diameter of the fastener 910 whereby the fastener 910 does not mechanically engage with the central bore 740. When in the assembled and “latched” configuration, the pins 690 of the inner cap 600 are received within the recesses 730 of the outer cap 700, and the central disc 720 of the outer cap 700 extends axially into the cavity 692 of the inner cap 600. When the outer cap 700 is coupled to the inner cap 600 the cavity 692 is encompassed by the chamber 650.

The angular orientation of the lighting element 10, and thus the general direction in which light is emitted from the LEDs, can be changed by adjusting the relative rotational position of the outer caps 700 with respect to the inner caps 600. To adjust the outer caps 700 with respect to the inner caps, a user applies an outwardly directed axial (or “pulling”) force on the outer cap 700, preferably by grasping the outer portion 705 which conveniently defines a flange because of the recessed intermediate portion 710. The outwardly directed axial force is a disengaging force that causes (a) the recesses 730 to separate and thereby disengage from the respective pins 690 and (b) the spring 930 to compress. The threaded fastener 910 and the spring 930 permit a limited amount of outward movement of the outer cap 700 until the spring 930 becomes fully compressed or “coil locks,” at which point further axially outward movement of the outer cap 700 is prevented. The spring 930, the fastener 910, the outer cap 700, and the inner cap 600 are configured such that when the spring 930 becomes fully compressed and prevents further outward movement of the outer cap 700, the central disc 720 of the outer cap 700 still extends axially into the cavity 692 of the inner cap 600, thereby maintaining the integrity of the high voltage enclosure provided by the enclosed chamber 650 that is cooperatively defined by the inner cap 600 and the outer cap 700. In this way, adjustment of the outer cap 700 with respect to the inner cap 600 does not expose or otherwise compromise the enclosed chamber 650.

When a sufficient outward axial force is applied to cause pin/recess disengagement, the operator, while maintaining the outward axial force, applies a rotational force on the outer cap 700 to adjust its angular orientation with respect to the inner cap 600. Once the desired angular orientation is reached, the operator releases the outward axial force and the compressed spring 930 exerts an axial biasing force on the outer cap 700 causing it to move towards the inner cap 600. Due to the inward movement, the pins 690 engage different ones of the recesses 730 thereby setting the angular position of outer cap 700 relative to the inner cap 600. The operator conducts this adjustment process, which is aided by the indicia 785 identifying the various angular orientations, for both cap assemblies 500 of the lighting element 10.

The inner and outer caps 600, 700 are structurally configured such that when there is disengagement of the pins 690 and recesses 730, the enclosed chamber 650 cannot be accessed which prevents tampering with the module 800 and, as mentioned above, maintains the integrity of the chamber 650. This aspect is accomplished by optimizing the dimensions and structural interaction of the outer portion 604 of the inner cap 600 and the inner portion 705 of the outer cap 700, including the central disk 720, the pins 690 and the recess 730.

The extent of rotational adjustment of the outer cap 700 relative to the inner cap 600 is limited by engagement between the key 697 of the central bore 695 of the inner cap 600 with the notch 750 of the central bore 740 of the outer cap 700. These over-rotation features permit the outer cap 700 to rotate a maximum of about 180 degrees with respect to the inner cap 600. Accordingly, the outer cap 700 can be rotated about 90 degrees in either direction from its center point, in about 15 degree increments. This flexibility covers substantially all lighting directions because the lighting element 10 can be plugged into an existing fixture in either an “upright” or “inverted” orientation due to the orientation of the pins 550. Accordingly, the lighting element 10 may be installed in the fixture with the light output pointing “up” and then removed and rotatably adjusted as described above and then installed in the fixture with the light output pointing “down.” By adjusting the rotational orientation of the outer cap 700 with respect to the inner cap 600, the user can adjust the direction of light emitted from the LEDs 315 and thus the lighting element 10 when the lighting element 10 is installed into the existing fluorescent lighting fixture.

While the specific embodiments have been illustrated and described, numerous modifications come to mind without significantly departing from the spirit of the invention, and the scope of protection is only limited by the scope of the accompanying claims.

What is claimed is:

1. An LED lighting element configured to receive electrical power from a fluorescent lighting fixture ballast, the LED lighting element comprising:
a base;
a light engine coupled to the base, the light engine including at least one LED;
an end cap coupled to the base and defining an enclosed chamber; and,
a converter module housed within the enclosed chamber, the converter module electrically coupled to the light engine and configured to convert AC power from the fluorescent lighting fixture ballast to DC power for powering the at least one LED.

2. The LED lighting element of claim 1, wherein the end cap is an adjustable end cap assembly including an inner end cap coupled to the base and an outer end cap adjustably coupled to the inner end cap.

3. The LED lighting element of claim 2, wherein the enclosed chamber is defined in part by the inner end cap and in part by the outer end cap.

4. The LED lighting element of claim 3, wherein the outer end cap is adjustable with respect to the inner end cap without exposing the enclosed chamber.

5. The LED lighting element of claim 2, wherein the outer end cap is rotatable with respect to the inner end cap.

6. The LED lighting element of claim 5, wherein the outer end cap includes a plurality of first alignment features and the inner end cap includes a plurality of second alignment features, and wherein the first alignment features are selectively engageable with different ones of the second alignment features to change a rotational orientation of the outer end cap with respect to the inner end cap.

7. The LED lighting element of claim 6, wherein the first alignment features are biased into engagement with the second alignment features.

8. The LED lighting element, of claim 2, further comprising pins electrically coupled to the converter module and adjustable with the outer end cap, the pins configured and arranged for electrically coupling to the fluorescent lighting fixture ballast.

9. The LED lighting element of claim 1, wherein the base has a length that extends along the lighting element and includes a first side to which the light engine is coupled, and a second side opposite the first side and defining a heat sink.

10. The LED lighting element of claim 9, wherein the first side includes a lens mounting arrangement for supporting at least one lens.

11. The LED lighting element of claim 9, wherein the second side includes a plurality of elongated fins defining the heat sink.

12. The LED lighting element of claim 1, wherein the base is elongated and includes a first end and a second end, and wherein the end cap is coupled to the first end, the LED lighting element further comprising a second end cap coupled to the second end, and a second converter module housed within the second end cap.

13. An LED lighting element configured to receive electrical power from a fluorescent lighting fixture ballast, the LED lighting element comprising:
an end cap assembly having a first cap engageable with the fluorescent lighting fixture ballast and a second cap rotatably coupled to the first cap for rotation about a longitudinal axis of the lighting element;
a plurality of LEDs coupled to the second cap for rotation therewith with respect to the first cap, each of the plurality of LEDs positioned to emit light in a first direction that is substantially perpendicular to the longitudinal axis; and,
a converter module electrically coupled to the LEDs for converting AC power received from the fluorescent lighting fixture ballast to DC power for powering the plurality of LEDs.

14. The LED lighting element of claim 13, wherein the first cap and the second cap cooperate to define a chamber, and wherein the converter module resides within the chamber.

15. The LED lighting element of claim 14, further comprising rotation means for permitting rotation of the second cap with respect to the first cap without exposing the chamber.

16. The LED lighting element of claim 13, wherein the converter module is fixedly attached to the first cap.

17. The LED lighting element of claim 13, further comprising an elongated base coupled to the second cap and extending along the longitudinal axis, wherein the plurality of LEDs are coupled to a first side of the base, and wherein a second side of the base defines a heat sink.

18. The LED lighting element of claim 17, wherein the base includes a lens mounting arrangement for supporting at least one lens.

19. The LED lighting element of claim 13, wherein the plurality of LEDs all lie in substantially the same plane.

20. The LED lighting element of claim 13, wherein the first cap includes a plurality of first alignment features and the second cap includes a plurality of second alignment features, and wherein the second alignment features are selectively engageable with different ones of the first alignment features to change a rotational orientation of the second cap with respect to the first cap.

21. The LED lighting element of claim 20, wherein the first alignment features are axially biased into engagement with the second alignment features.

22. The LED lighting element of claim 13, wherein one of the first cap and the second cap includes a key and the other of the first cap and the second cap includes a slot, and wherein the key and the slot cooperate to limit an extent of rotation of the second cap with respect to the first cap.

23. The LED lighting element of claim 13, further comprising pins electrically coupled to the converter module, wherein the pins are rotatable with and extend through the second cap, and wherein the pins are configured and arranged for electrically coupling to the fluorescent lighting fixture ballast.

24. An LED lighting element configured to receive electrical power from a fluorescent lighting fixture ballast, the LED lighting element comprising:
an elongated base defining a longitudinal axis and having a first side and a second side, the first side including a lens mounting arrangement defining a channel, the second side including a plurality of outwardly extending fins that define a heat sink;
a light engine coupled to the base, the light engine including a plurality of LEDs;
a lens positioned within the channel and overlying the light engine;
a pair of adjustable end cap assemblies, each end cap assembly affixed to a respective end of the base and including an outer end cap rotatably coupled to an inner end cap for rotation about the longitudinal axis, one of the inner end cap and the outer end cap including a portion having a plurality of circumferentially spaced apart pins, and the other of the inner end cap and the outer end cap including a portion defining a plurality of circumferentially spaced apart recesses configured to receive the pins, each end cap assembly including a biasing member biasing the pins into engagement with the recesses; and,
two converter modules electrically coupled to the plurality of LEDs and configured to convert AC power received from the fluorescent lighting fixture ballast to DC power for powering the plurality of LEDs, each converter module located within a chamber formed in a respective one of the end cap assemblies.

25. The LED lighting element of claim 23, wherein for each end cap assembly the outer end cap and the inner end cap cooperate to define the chamber, and wherein the outer end cap is rotatable with respect to the inner end cap without exposing the chamber.
